(19) United States
(12) Patent Application Publication
(10) Pub. No.: US 2010/0095491 A1
(43) Pub. Date: Apr. 22, 2010

(54) ATTACHMENT MEMBER AND METHOD FOR MANUFACTURING THE SAME

(75) Inventors: Toyohisa HIROKI, Chiba-ken (JP); Koji SANO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Kabushiki-Kaisya TOSKA, Tokyo (JP)

(21) Appl. No.: 12/507,997

(22) Filed: Jul. 23, 2009

(30) Foreign Application Priority Data
Oct. 22, 2008 (JP) 2008-271653

(51) Int. Cl. A44B 13/00; A44B 99/00; B23P 25/00

(52) U.S. Cl. 24/457; 24/594.1; 24/593.1; 24/592.1; 29/458

(57) ABSTRACT

Attachment members including an elongate member molded from at least one elastomer and a rigid or hard fixing element arranged at one or both ends of the elongate member, and methods for manufacturing such attachment members. The fixing element may be molded in advance and thereafter firmly coupled to the elastomeric elongate member, which has also been molded in an appropriate manner.

### BACKGROUND OF THE INVENTION

1. Field of the Invention

The present invention relates generally to an attachment member and more particularly, to an attachment member used for hanging a tag on a commodity or fastening or binding something. The present invention also relates to methods for manufacturing such attachment members.

2. Description of the Related Art

Attachment members for hanging a tag on a commodity or fastening or binding something are known. Typically, such an attachment member is formed using a reinforced fiber material obtained by performing a drawing process on a plastic. However, formed in such a manner, the attachment member cannot be easily cut when attached to the commodity.

The attachment members usually include a receiving section and an insertion section that is fitted into the receiving section. Both the receiving and insertion sections are integrally formed as part of the attachment member at respective ends thereof. The receiving and insertion sections are molded primarily from polypropylene, and they are connected together to cause the attachment member to assume the form of a loop.

A disadvantage of prior art attachment members is that since the fiber used to form such a prior art attachment member is not expandable, a number of attachment members must be produced, each with a different size, to enable use of the attachment members for various size commodities. As a result, these prior art attachment members are unsuitable for most purposes other than hanging a tag and fastening or binding something, and are unsuitable for wrapping an object around another object, for example.

Instead of a non-expandable fiber, it has been considered to use an expandable rubber material composition. However, most rubber materials are vulnerable to deterioration upon aging and exposure to exterior atmospheric conditions and are thus unable to be used for long periods of time. Another drawback of the use of rubber material to connect the receiving and insertion sections of an attachment member is that when the receiving and inserting sections are made of polypropylene, the polypropylene receiving and inserting sections and the rubber material do not allow a strong coupling force to be established that is sufficiently resistant to shock or application of a force. Therefore, the receiving and inserting sections may separate from the rubber connecting member.

Exemplifying attachment members used for hanging a tag on a commodity or fastening or binding something are disclosed in JP-A-7-279018.

### SUMMARY OF THE INVENTION

A general embodiment of an attachment member in accordance with the invention includes an elongate member molded from an elastomer and having a rigid or hard fixing element at one or both ends thereof. The elongate member may be a linear or substantially linear member having a substantially circular cross-section. The fixing element may be a two-part fixing element including a receiving section having an engaging portion at one end of the elongate member, and an insertion section at another end of the elongate member. The insertion section includes an engagement portion which is configured to be fitted at least partially into and/or through the receiving section and more particularly, to engage with the engaging portion of the receiving section. The fixing element at both ends of the elongate member may be provided in the form of an assembly by further combining it with a respective runner member that is connected to each of the receiving section and the insertion section.

An additional and optional feature of an attachment member in accordance with the invention is a hook portion integral with part of the receiving section. Further, the elongate member may be in the form of a strip, and the fixing element may be in the form of a clip portion. Alternatively, the elongate member may be in the form of a strip, and the fixing element may be provided as an element configured for binding purpose, i.e., including a receiving section which has an engaging portion at one end of the elongate member and engagement portions on one surface of the elongate member at another end thereof, the engagement portions of the elongate member being formed at substantially constant intervals to be engaged with the engaging portion of the receiving section.

A first embodiment of a method for manufacturing an attachment member in accordance with the invention includes extrusion-molding an elongate member from elastomeric material, e.g., an elastomer, and inserting the elongate member into a rigid or hard fixing element. The attachment member may also be obtained by preparing an elongate member from an elastomer using, for example, injection molding and attaching a rigid or hard fixing element to an end of the elongate member after cutting the member into appropriate or desired dimensions, e.g., a desired length.

The manufacturing method therefore provides an attachment member as described above, i.e., one including an elongate member molded from an elastomer and that has a rigid or hard fixing element at one or both ends thereof. The method may include molding the fixing element in advance and thereafter firmly coupling the elastomeric elongate member, which is molded in an appropriate manner, with the fixing element.

In some embodiments of the manufacturing method, the fixing element has a portion arranged on each end of the elongate member. One of the fixing element portions may be a receiving section having an engaging portion, and the other may be an insertion section having an engagement portion which is inserted at least partially into and/or through the receiving section to be engaged and locked with the engaging portion of the receiving section. Each of the fixing elements may have a coupling shaft configured to be accommodated in an end portion of the elongate member. Each coupling shaft may be formed with a groove into which the elastomer enters to achieve rigid integration of the attachment member and the respective fixing element.

The method for manufacturing an attachment member in accordance with the invention may be to form attachment members usable as rubber bands for hair.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1A is a front view of a first embodiment of an attachment member in accordance with the invention;

FIG. 1B is a partial rear view of the attachment member shown in FIG. 1A showing a receiving section thereof;

FIG. 1C is a front view of the receiving section of the attachment member shown in FIG. 1A;

FIG. 1D is a front view of the attachment member shown in FIG. 1A showing the engaged or connected state in which the receiving and insertion sections thereof are engaged with one another;

FIG. 2A is a front view of a second embodiment of an attachment member in accordance with the invention;

FIG. 2B is a side view of the attachment member shown in FIG. 2A;

FIG. 2C is a front view of the receiving section of the attachment member shown in FIG. 2A;

FIG. 2D is a rear view of the insertion section of the attachment member shown in FIG. 2A;

FIG. 2E is a cross-sectional view taken along the line 2E-2E in FIG. 2B;

FIG. 2F is a cross-sectional view taken along the line 2F-2F in FIG. 2B;

FIG. 2G is a cross-sectional view taken along the line 2G-2G in FIG. 2B;

FIG. 2H is an enlarged view of a portion of the insertion section of the attachment member shown in FIG. 2A;

FIG. 3A is a front view of a third embodiment of an attachment member in accordance with the invention shown arranged on runner members to form an attachment member assembly;

FIG. 3B is a side view of the attachment member assembly shown in FIG. 3A;

FIG. 3C is a rear view of the attachment member assembly shown in FIG. 3A;

FIGS. 3D and 3E are left and right side views of the attachment member assembly shown in FIG. 3A;

FIG. 3F is a cross-sectional view taken along the line 3F-3F in FIG. 3C;

FIG. 3G is an enlarged view of a portion of a receiving section of the attachment member assembly, designated 3G, shown in FIG. 3B;

FIG. 4A is a front view of a fourth embodiment of an attachment member in accordance with the invention shown arranged on runner members to form an attachment member assembly;

FIG. 4B is a side view of the attachment member assembly shown in FIG. 4A;

FIG. 4C is a rear view of the attachment member assembly shown in FIG. 4A;

FIG. 4D is a cross-sectional view taken through the receiving hole of the receiving section of the attachment member shown in FIG. 4A;

FIG. 4E is a cross-sectional view taken along the line 4E-4E in FIG. 4A;

FIG. 4F is a cross-sectional view taken along the line 4F-4F in FIG. 4B;

FIGS. 4G and 4H are left and right side views of the attachment member assembly shown in FIG. 4A;

FIG. 5A is a front view of a fifth embodiment of an attachment member in accordance with the invention;

FIG. 5B is a side view of the attachment member shown in FIG. 5A;

FIG. 5C is a cross-sectional view of the attachment member assembly shown in FIG. 5A taken along the line 5C-5C;

FIG. 5D is a cross-sectional view taken along the line 5E-5E in FIG. 5B;

FIG. 5E is an end view of a hook portion of the attachment member shown in FIG. 5A;

FIG. 5F is a top view of the hook portion of the attachment member shown in FIG. 5A;

FIG. 5G is an enlarged view of the portion designated 5G in FIG. 5C;

FIG. 5H is an enlarged view of the portion designated 5I in FIG. 5A;

FIG. 5I is a cross-sectional view taken along the line 5I-5I in FIG. 5H;

FIG. 6A is a front view of a sixth embodiment of an attachment member in accordance with the invention;

FIG. 6B is a side view of the attachment member shown in FIG. 6A;

FIG. 6C is a cross-sectional view of the attachment member shown in FIG. 6A taken along the line 6C-6C in FIG. 5A;

FIG. 6D is a cross-sectional view of the attachment member shown in FIG. 6A taken along the line 6D-6D in FIG. 5A;

FIG. 6E is a view taken in the direction of arrow 6E in FIG. 6A;

FIG. 6F is a cross-sectional view taken along the line 6F-6F in FIG. 6A;

FIG. 6G is a front view of the engaging protrusion on the attachment shown in FIG. 6A;

FIG. 6H is an end view of the attachment member shown in FIG. 6A;

FIG. 6I is a perspective view of the attachment member shown in FIG. 6A;

FIG. 7A is a side view of a seventh embodiment of an attachment member in accordance with the invention;

FIG. 7B is a partial, front view of the attachment member shown in FIG. 7A;

FIG. 7C is a rear view of the attachment member shown in FIG. 7A;

FIG. 7D is a partial top view of the attachment member shown in FIG. 7A;

FIG. 8 shows a first method for manufacturing an attachment member in accordance with the invention;

FIGS. 9A and 9B show a modification of the manufacturing method shown in FIG. 8; and

FIG. 10 is a partially cutaway, perspective view of an attachment member manufactured in accordance with another method for manufacturing an attachment member in accordance with the invention.

### DESCRIPTION OF PREFERRED EMBODIMENTS

Referring to the accompanying drawings wherein like reference numerals refer to the same or similar elements, an attachment member in accordance with the invention includes an elongate member 1. The elongate member 1 is preferably linear or substantially linear, molded from an elastomer and has a substantially circular cross-sectional shape. In one particularly suitable embodiment, the elongate member 1 has a diameter of about 1.2 mm and a length of about 5 cm to about 6 cm.

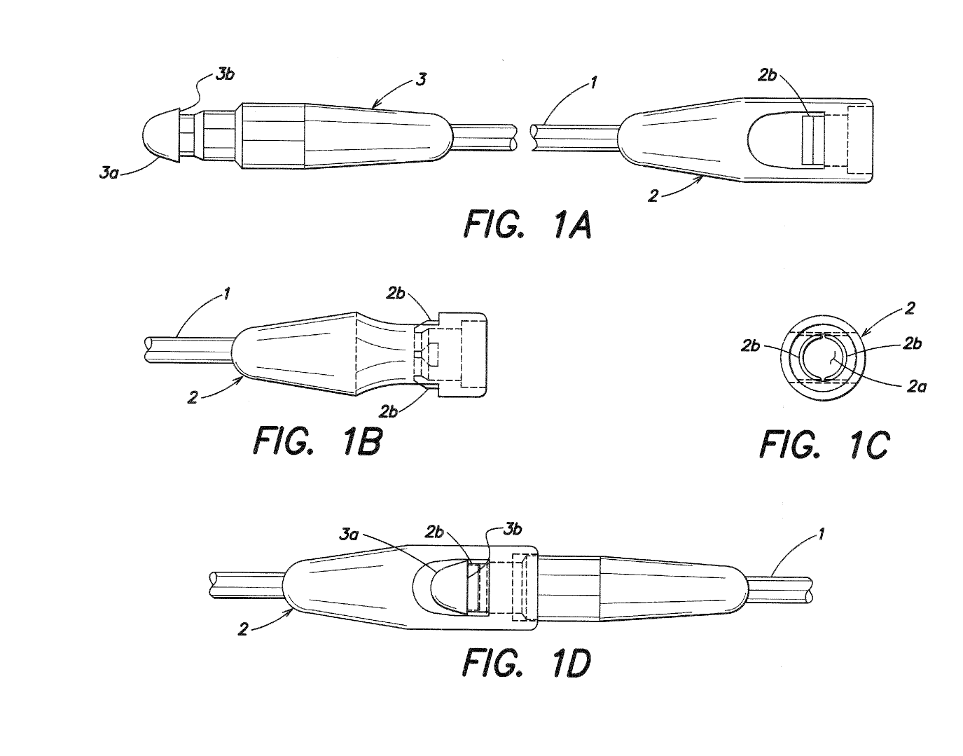

Referring specifically to the attachment member shown in FIGS. 1A, 1B, 1C and 1D, a receiving section 2 is integrally arranged at one end of the elongate member 1. The receiving section 2 includes a receiving hole 2a and a pair of opposing engaging portions 2b having resilient properties and which are arranged at least partially in the receiving hole 2a. An insertion section 3 is integrally arranged at the other end of the elongate member 1. The insertion section 3 includes a head portion 3a configured to be at least partially insertable into and/or through the receiving hole 2a of the receiving section 2 and a step-like engagement portion 3b formed at a base end of the head portion 3a (see FIG. 1A). The engagement portion 3b of the insertion section 3 is engaged and locked with the engaging portions 2b of the receiving section 2, as shown in FIG. 1D, to cause the attachment member to assume the form of a loop in its connected state. This attachment member is particularly useful for hanging a tag on a commodity, such as clothes, to show the price and quality of the clothes.

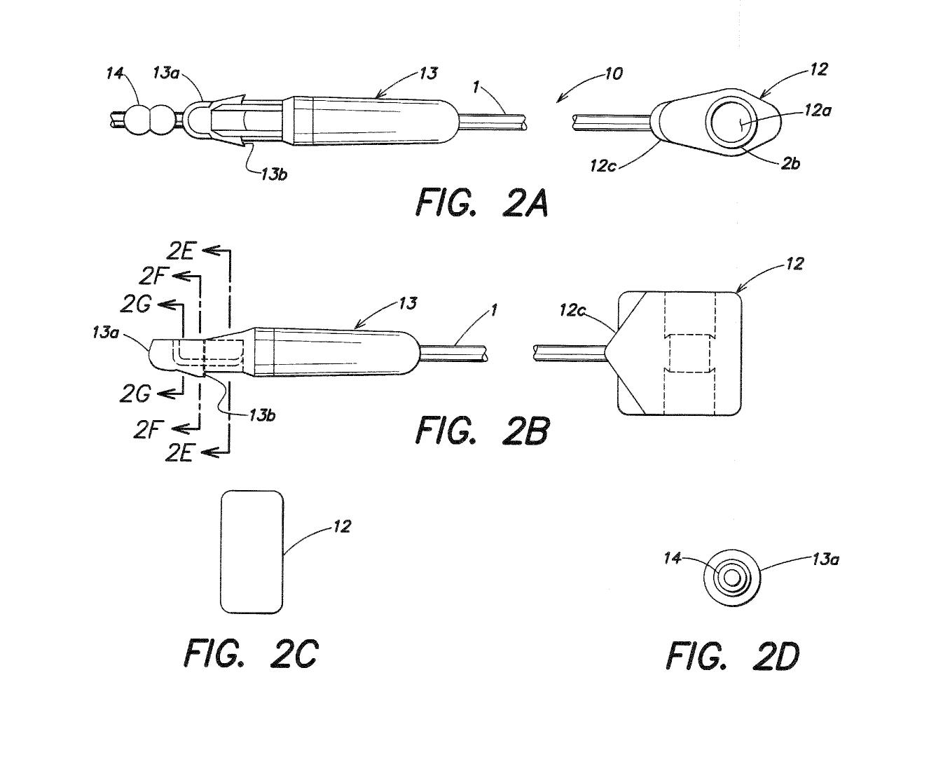

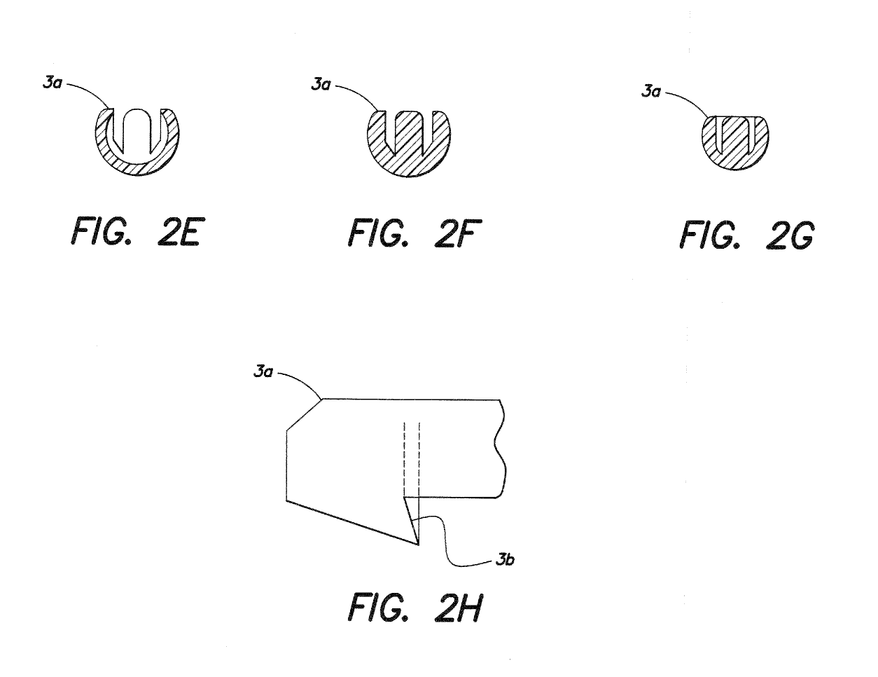

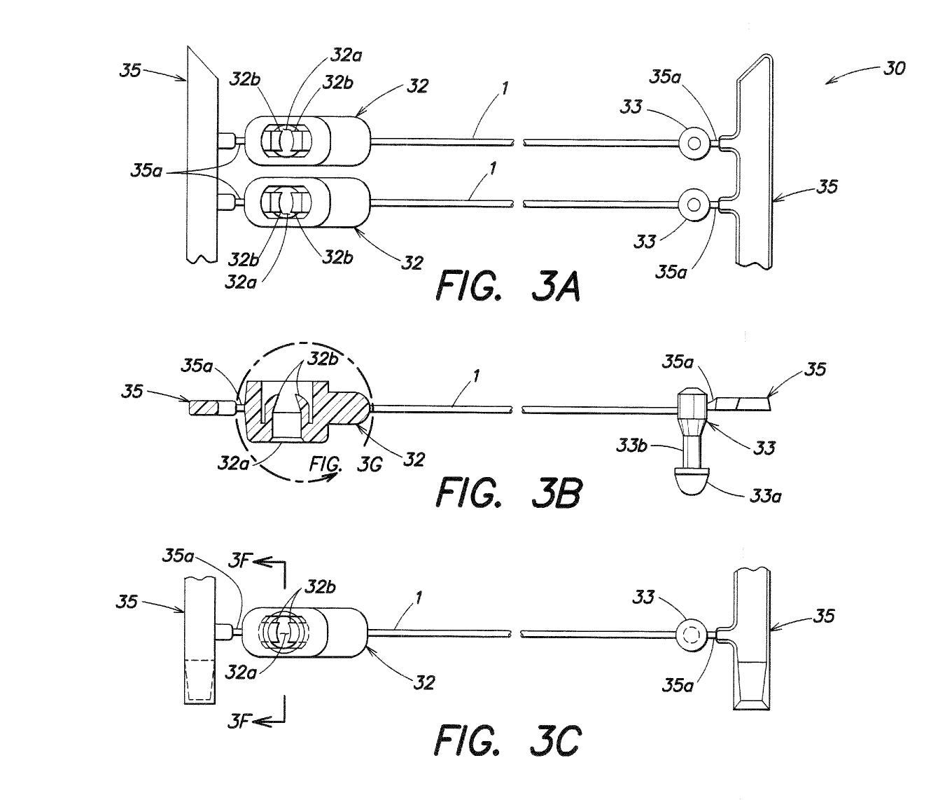

FIGS. 2A-2H show a second embodiment of an attachment member in accordance with the invention that is designated generally as 10 and includes a receiving section 12 having a receiving hole 12a that extends in a direction substantially perpendicular to a longitudinal direction of the elongate member 1. An engaging portion 12b is formed as an annular flange inside the receiving hole 12a (see FIG. 2A). An insertion section 13 is indented or cut halfway along its length to form a head portion 13a which is located at an end of the insertion section 13, and an engaging portion 13b is formed on a remaining part of the head portion 13a. As shown in FIG. 2A, there is a stopper 14 which is a part of the elongate member 1 formed continuously or integrally with the head portion 13a of the insertion section 13 by, for example, extrusion molding as described later. The stopper 14 is arranged in a receiving bulge portion 12c of the receiving section 12 formed on a side of the receiving section 12 continuous or integral with the elongate member 1 (see FIGS. 2A and 2B) and is operative to prevent the insertion section 13 from separating from the receiving section 12 after they have been connected or engaged together.

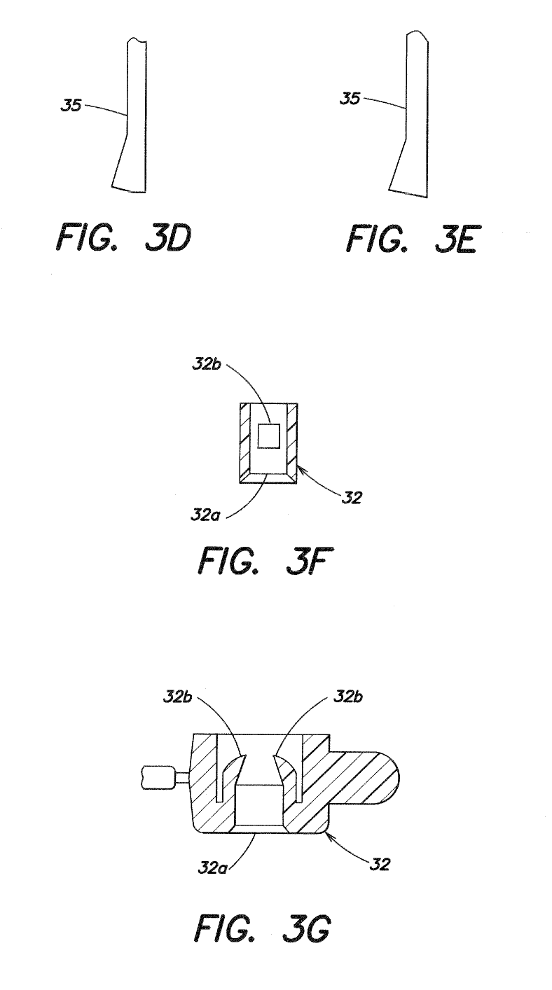

Referring now to FIGS. 3A-3G, a third embodiment of an attachment member in accordance with the invention is designated generally as 30 and includes a receiving section 32 having a receiving hole 32a and a pair of opposing engaging portions 32b (see FIG. 3G), and an insertion section 33 that extends in a direction substantially perpendicular to a longitudinal direction of the elongate member 1. Insertion section 33 includes a head portion 33a and a step-like engaging portion 33b formed at a base of the head portion 33a. In this case, an assembly is formed by providing a plurality of the attachment members 30 in parallel with each other at substantially constant intervals and connecting the receiving sections 32 and the insertion sections 33 to runner members 35 through connecting portions 35a. The runner members 35 and connecting portions 35a are preferably made of polypropylene and can be cut, e.g., to enable separation of the attachment members 30 from the runner members 35. The runner members 35 on each side of the attachment members 30 are substantially parallel to each other, and in one embodiment, the runner members 35 are set or positioned on a dedicated mounting apparatus that allows the attachment members 30 to be continuously mounted to respective target positions.

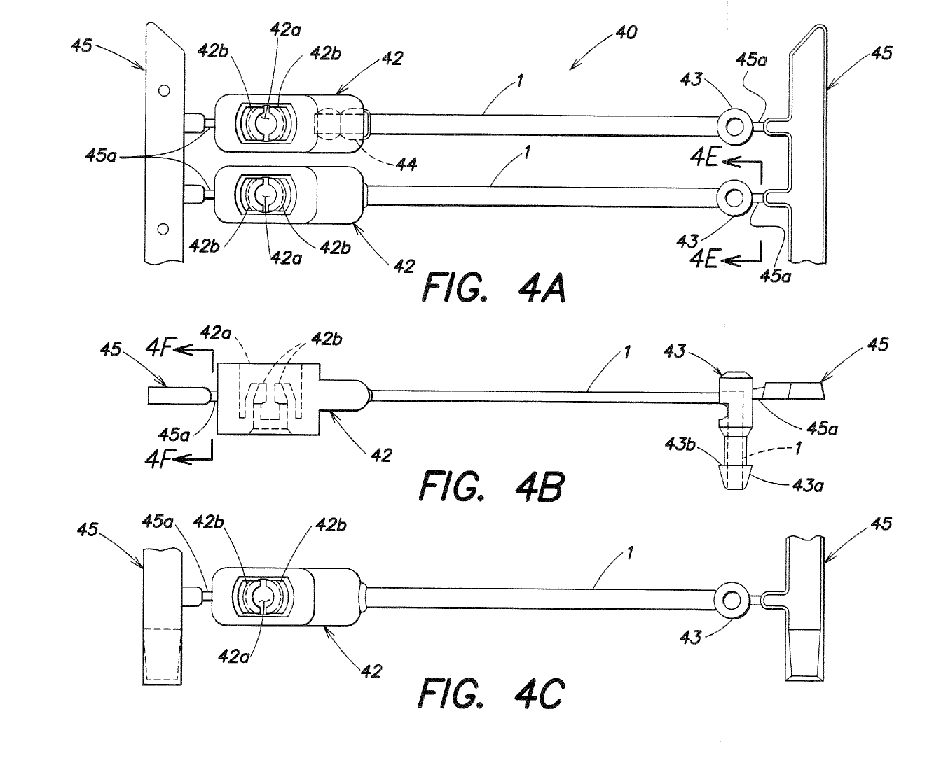

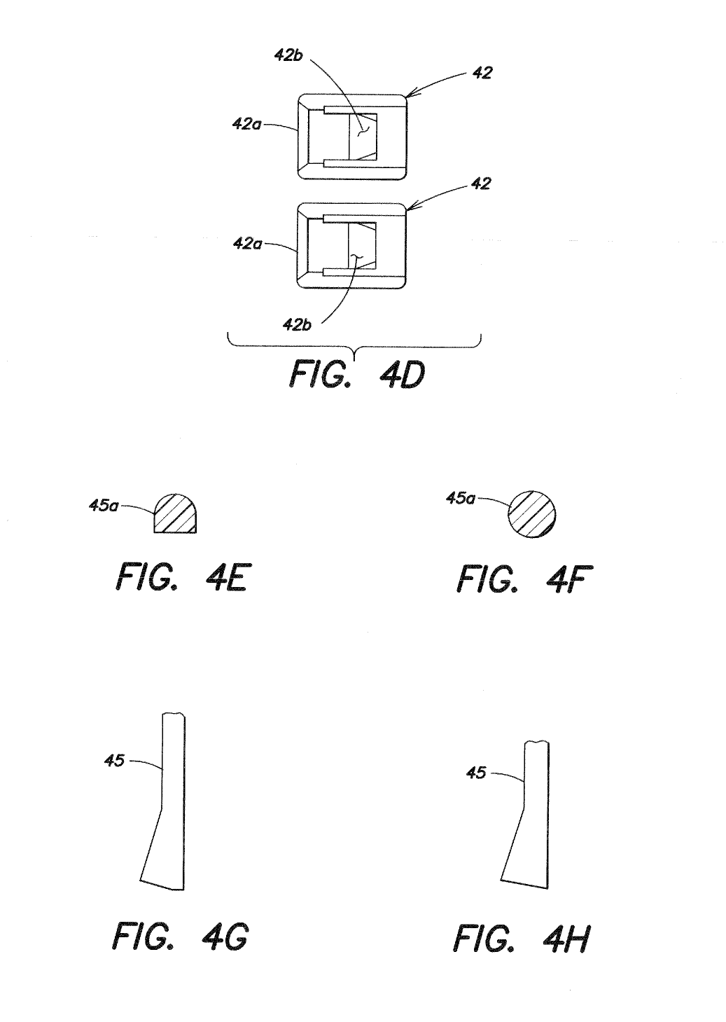

Referring now to FIGS. 4A-4H, a fourth embodiment of an attachment member in accordance with the invention is designated generally as 40 and includes a receiving section 42 having a receiving hole 42a and a pair of opposing engaging portions 42b, and an insertion section 43 that extends in a direction substantially perpendicular to a longitudinal direction of the elongate member 1. Insertion section 43 includes a step-like engaging portion 43b formed at a base of a head portion 43a. An assembly is formed by providing a plurality of the attachment members 40 in parallel with each other at substantially constant intervals and connecting the receiving sections 42 and the insertion sections 43 to runner members 45 through connecting portions 45a. The runner members 45 and connecting portions 45a are preferably made of polypropylene and can be cut, e.g., to enable separation of the attachment members 40 from the runner members 45. The runner members 45 on each side of the attachment members 40 are substantially parallel to each other, and in one embodiment, the runner members 45 are set or positioned on a dedicated mounting apparatus that allows the attachment members 40 to be continuously mounted to respective target positions.

Insertion section 43 includes a hollow interior into which the end of the elongate member 1 is inserted (see FIG. 4B wherein the elongate member 1 in the interior of the insertion section 43 is shown in dotted lines). As such, the elongate member 1 is bent substantially perpendicularly and urged into the insertion section 43 to extend up to a head portion 43a of the insertion section 43.

A stopper 44 is optionally formed as a part of the elongate member 1, continuously or integrally with the receiving section 42 by, for example, extrusion molding as described later. Stopper 44 is operative to prevent the receiving section 42 from separating from the elongate member 1.

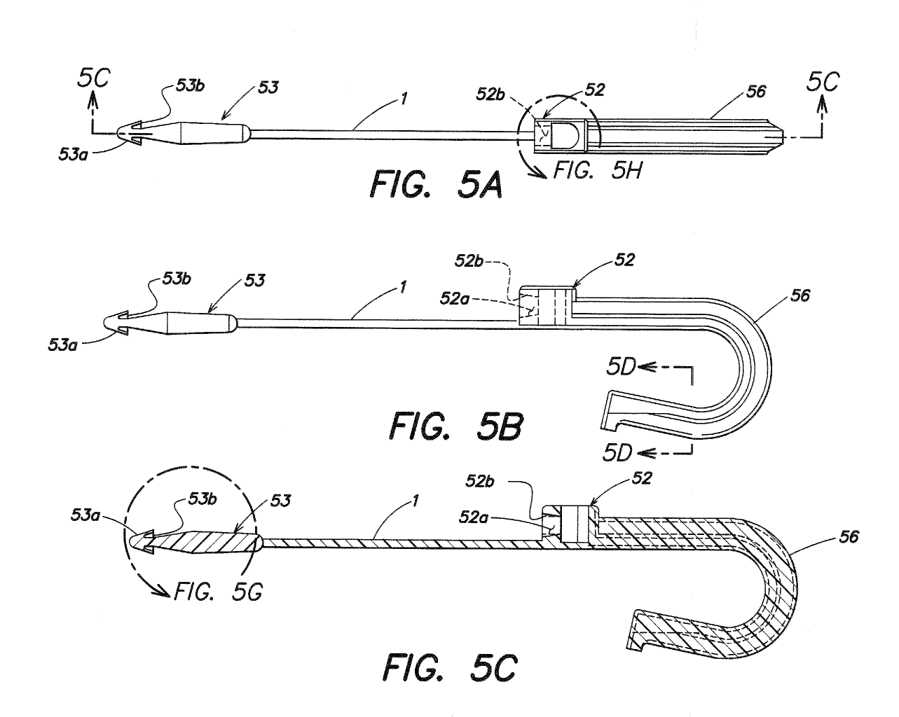

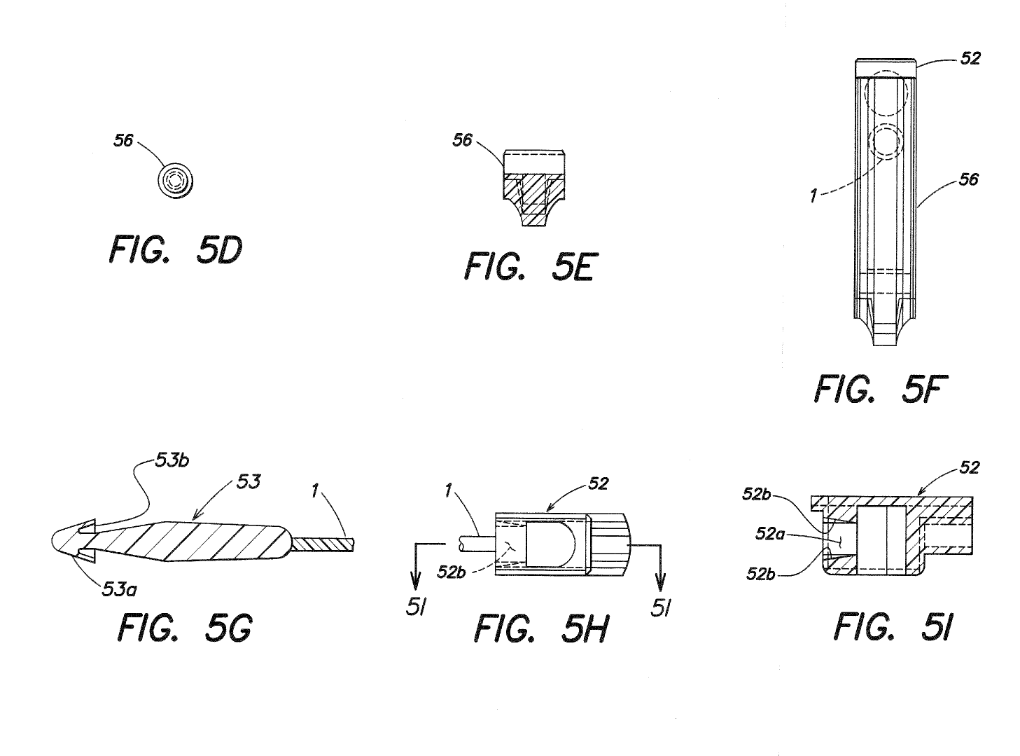

Referring now to FIGS. 5A-5I, a fifth embodiment of the attachment member in accordance with the invention is designated generally as 50 and includes a hook portion 56 arranged continuously and integrally with a receiving section 52 situated at one end of an elongate member 1. In this case, the elongate member 1 is connected to one side of the receiving section 52 extending alongside a receiving hole 52a, and the receiving section 52 also includes a pair of opposing engaging portions 52b. An engagement portion 53b of an insertion section 53 is formed in the shape of an umbrella (see FIG. 5G). The insertion section 53 also includes a head portion 53a.

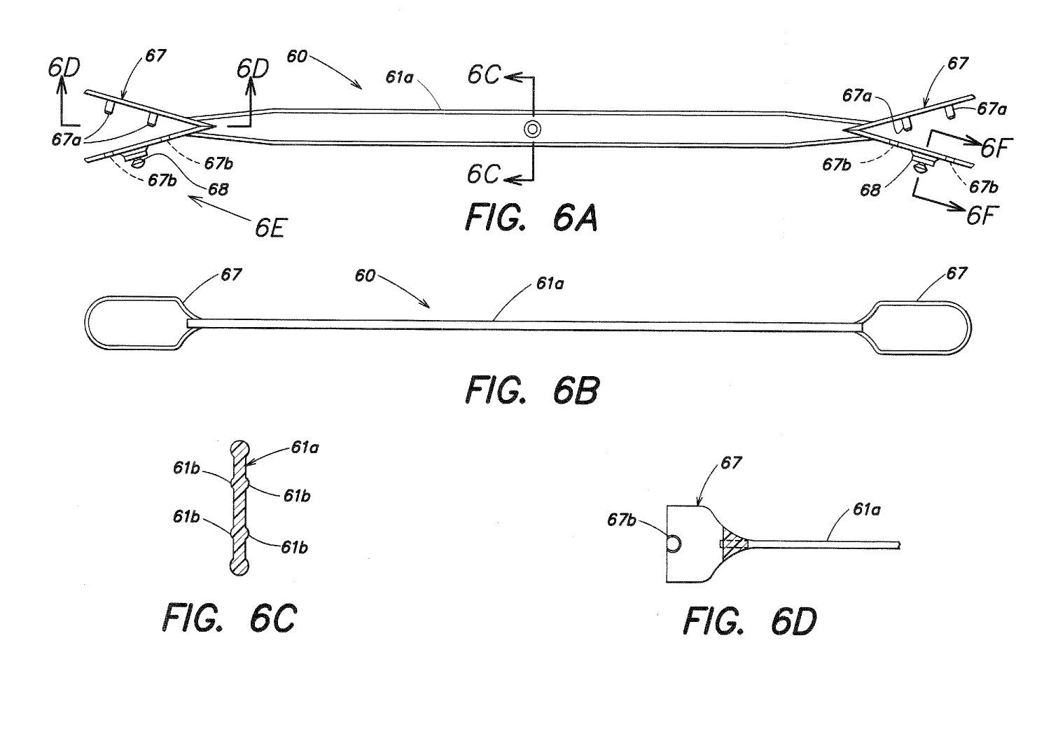

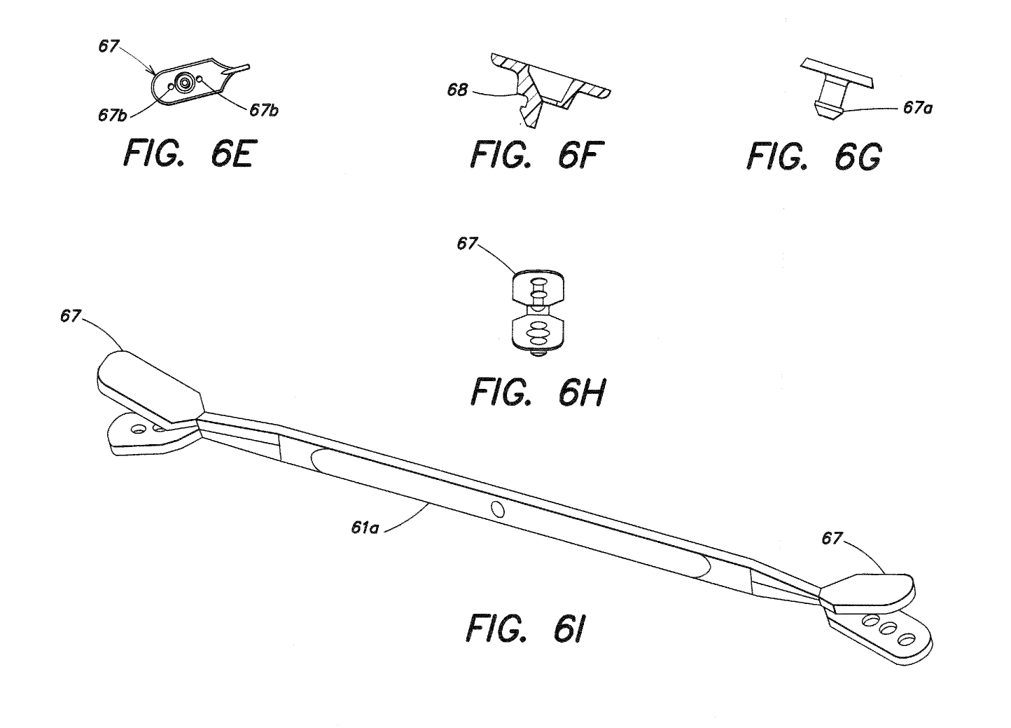

Referring now to FIGS. 6A-6I, a sixth embodiment of an attachment member in accordance with the invention is designated generally as 60 and comprises an elongate member 61a in the form of a strip having a width that decreases toward its two ends. The attachment member 60 may be used as a handle (tack) of a carry bag by being mounted on the periphery of an opening of the bag. The attachment member 60 also includes clip portions 67 arranged integrally at both ends of the elongate member 61a such that they can sandwich the periphery of the bag opening when mounted thereon. The clip portions 67 are generally V-shaped, and one or engagement protrusions 67a protrudes from each inner surface on one side of the respective clip portions 67. Receiving portions 67b are arranged on inner walls on another side of the clip portions 67 and are configured to engage with the engaging protrusions 67a, including when they extend through the periphery of the bag opening.

Attachment member 60 also includes a reinforcing section 68 located inside the periphery of the opening of the bag to which the attachment is mounted. Two ribs 61b are formed on two respective surfaces of the elongate member 61a to extend in a longitudinal direction thereof such that the attachment member 60 can be provided with a comfortable feel of grip and improved strength (see FIG. 6C).

The elongate member 61a may be substantially linear, molded from an elastomer and have a cross-sectional shape as shown in FIG. 5C. In one embodiment, the elongate member 61a has a length of about 5 cm to about 6 cm.

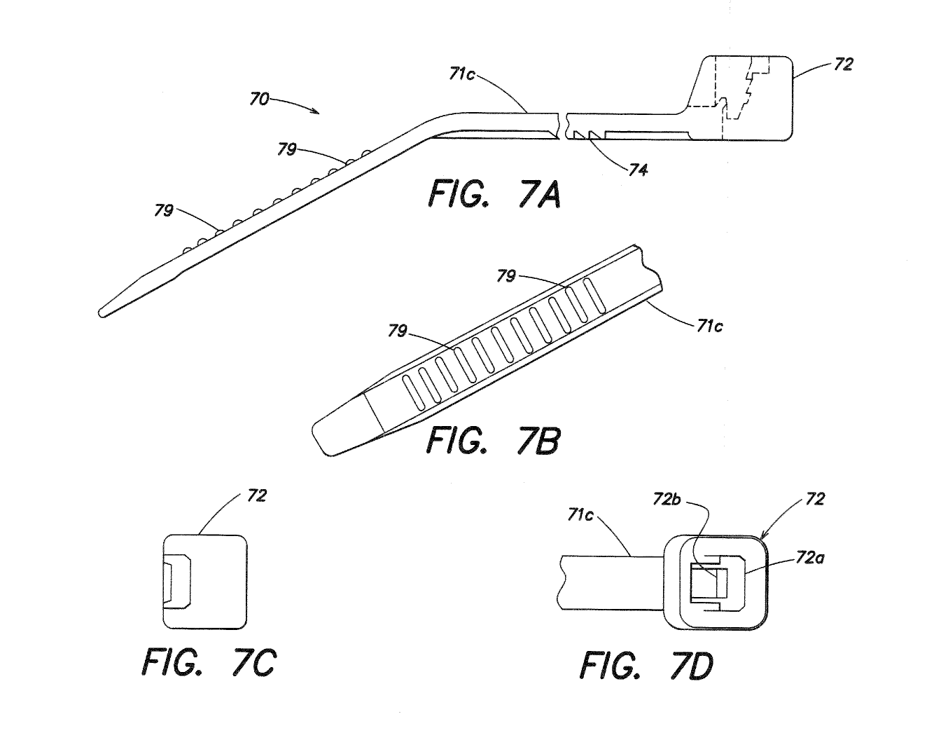

Referring now to FIGS. 7A-7D, a seventh embodiment of an attachment member in accordance with the invention is designated generally as 70 and comprises an elongate member 71c having the form of a substantially flat strip, e.g., a strip with opposed substantially planar surfaces. A receiving section 72 is integrally arranged integral at one end of the elongate member 71c so that a receiving section is formed with a through, receiving hole 72a and an engaging portion 72b located in the receiving hole 72a. The other end of the elongate member 71c is slightly tapered such that the tip of the elongate member 71c can be easily inserted into the receiving hole 72a. Anti-slip protrusions 79 having a substantially semi-circular sectional shape are integrally formed with the elongate member 71c on a top surface thereof at predetermined pitches. Ratchets 74 are consecutively formed on a bottom surface of the elongate member 71c from the area of the receiving section 72 up to the area of a tip of the elongate member 71c. The ratchets 74 are engaged with the engaging portion 72b to prevent the elongate member 71c from coming off.

The attachment member 70 may preferably be used as a tying band for tying and fastening wire materials or the like.

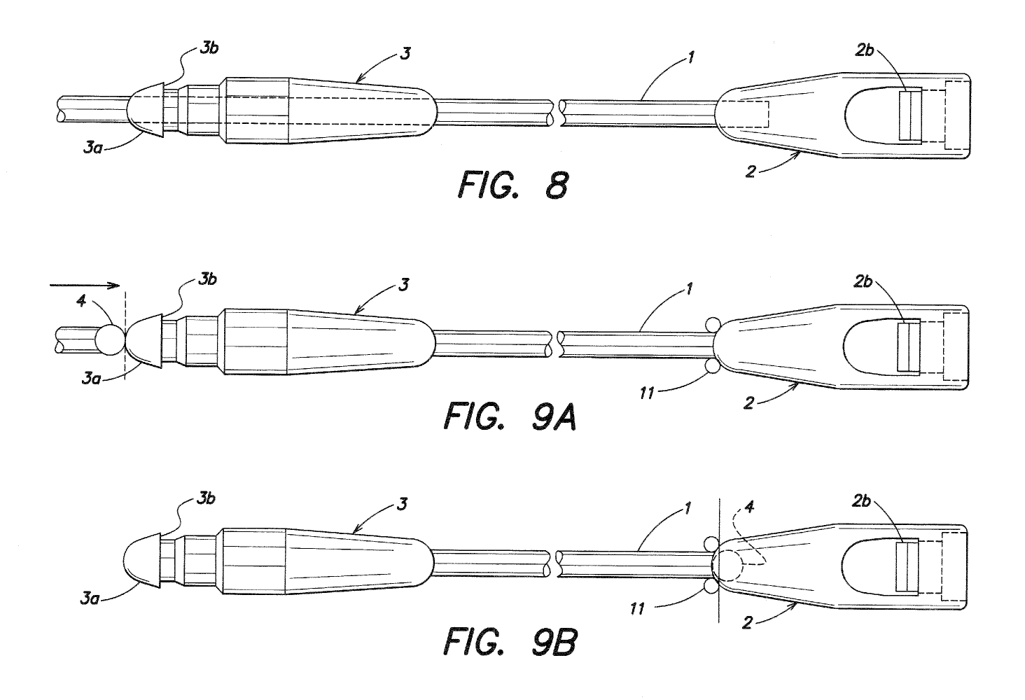

Methods for manufacturing attachment members described above will now be described with reference to FIGS. 8-10, FIGS. 8, 9A and 9B show a first method for manufacturing an attachment member in accordance with the invention. In a first step in the method, an elongate member 1 made of an elastomer having a substantially circular sectional shape is molded, and the elongate member 1 is thereafter inserted into an insertion section 3 in a front-to-rear direction of the insertion section 3 using, for example, a die. The elongate member 1 is further pushed through the insertion section 3 until a tip of the elongate member 1 is inserted into a receiving section 2 located at a predetermined distance from the insertion section 3 in a front-to-rear direction of the insertion section 3. The elongate member 1 is cut after being pushed into an apex part of the receiving section 2. The elongate member 1 may be stopped in a position at which the elongate member 1 is considered to have been sufficiently inserted.

In order to prevent the elongate member 1 from coming out the receiving section 2, a stopper 4, as in any of the embodiments described above, is arranged on a part of the elongate member 1, and the elongate member 1 is cut when the stopper 4 abuts an apex surface of a head portion 3a of the insertion section 3. Subsequently, the inserting operation is resumed with the stopper 4 serving as the leading edge. Thus, the stopper 4 is pressed forward into the receiving section 2 to prevent the elongate member 1 from coming off. A guide gate 11 may be provided to aid in the insertion of the elongate member 1 into the receiving section 2 (see FIGS. 9A and 9B).

Another method for manufacturing any of the attachment members described above is a double molding method in which the receiving section and the insertion section are molded using, for example, a first die and are moved apart from each other, and the elongate member made of an elastomer is set between the receiving section and the insertion section. Then, parts of those elements in contact each other are attached together, e.g., fused together. The fusing is carried out by applying heat. When contact surfaces between the receiving section and elongate member and between the insertion section and the elongate element are constructed to be rough surfaces, fusing takes place over large surface areas, which allows rigid coupling between those elements.

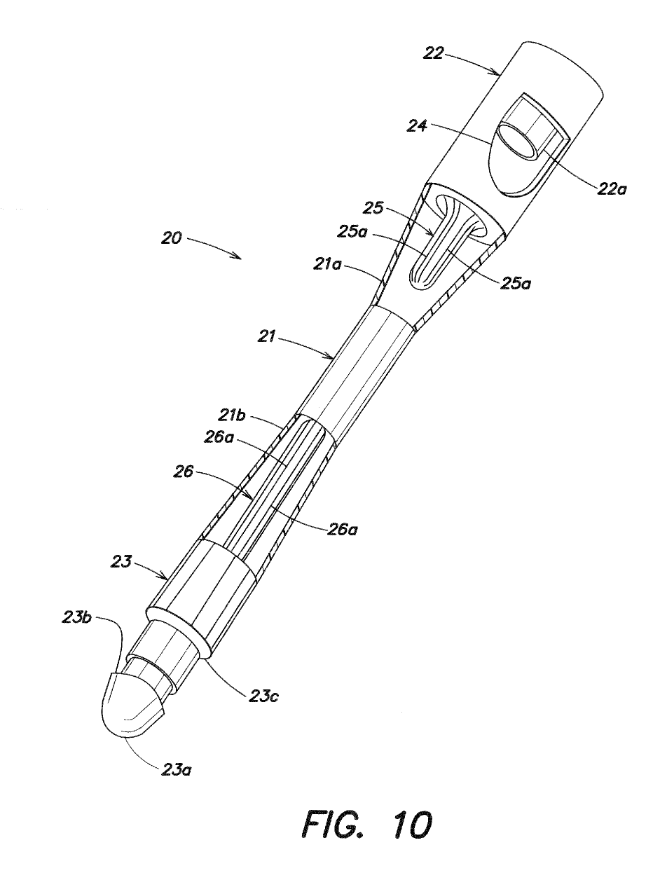

Referring now to FIG. 10, an attachment member manufactured in this method is designated generally as 20 and includes an elongate member 21 made of an elastomer. The elongate member 21 is obtained, for example, by performing injection molding using a die. The elongate member 21 preferably has a small diameter in a middle thereof, and the elongate member 21 is also preferably inversely tapered toward two ends thereof to provide large diameter parts 21a and 21b.

A receiving section 22 serves as a fixing element molded from a hard material, which is preferably polypropylene, is firmly coupled to an end face of one of the large diameter parts, i.e., the large diameter part 21a. An insertion section 23, which is also molded from polypropylene, is firmly coupled to an end face of the other large diameter part, i.e., the large diameter part 21b.

The receiving section 22 and the insertion section 23 may be molded in advance using, for example, a die, and the receiving section 22 may be formed with a receiving hole at an end face thereof. The receiving hole has a cylindrical shape, and an engaging portion 22a is formed on the bottom end of the hole. The engaging portion 22a can be observed through a window hole 24 to check the state of engagement with the insertion section 23.

An insertion guide 23a having a spherical surface is formed at the tip of the insertion section 23 to guide insertion of the insertion section 23 into the receiving hole of the receiving section 22. A base end of the insertion guide 23a has a step portion which serves as a portion to be engaged with the engaging portion 22a of the receiving section 22. Further, a stopper 23c having a larger diameter than a diameter of the opening of the receiving hole is formed at the insertion section 23 to regulate the insertion length of the insertion section 23.

Coupling shafts 25 and 26 are integrally arranged at base ends of the receiving section 22 and the insertion section 23, respectively, or on the sides of the sections to be coupled with the elongate member 21. The coupling shafts 25 and 26 may be formed with grooves 25a and grooves 26a, respectively, and the grooves 25a, 26a extend substantially in the axial directions of the respective shafts 25, 26.

The coupling shafts 25 and 26 of the receiving section 22 and the insertion section 23 are set on the die used for molding the elongate member 21 from an elastomer, and the elastomer material is injected into the die after the shafts 25, 26 are set. At this step, the injected elastomer material is solidified into a structure in which the coupling shafts 25 and 26 are embedded, whereby the elastomer is integrally coupled with the receiving section 22 and the insertion section 23. At this time, the elastomer material enters and tightly fits with grooves 25a and 26a to make the integral coupling more rigid. The coupling shafts 25 and 26 thus serve as cores of parts which are held by fingers or the like when the attachment member 20 is used as a complete product. The coupling shafts 25, 26 also prevent the complete product from bending to keep the coupling between the receiving section 22 and the insertion section 23 in a preferable state.

For example, the attachment member 20 thus manufactured may be used as a hair rubber band that is a type of accessory. In this case, the elongate member 21 itself may be colored, and metal powder or foil may be mixed into it. Alternatively, gold threads, silver threads or threads having other colors may be wound around the elongate member 21.

According to any of the above-described manufacturing methods, the attachment member can be finished with high precision without a complicated step of fusing end faces thereof in spite of the fact that double molding is used.

Although the elongate member 21 of some of the exemplifying embodiments described above has different diameters at the center and ends thereof, the invention is not limited to such a configuration, and the elongate member may alternatively have a straight shape or constant diameter along its entire length. In addition, although the grooves 25a and 26a have been described as extending in the axial direction of the elongate member, the invention is not limited to such a configuration, and one or both of the grooves may extend in directions across the axis, i.e., non-axial directions. Further, with respect to attachment member 20, the same advantage as described above can be achieved by forming protrusions having various shapes on the surface of the coupling shafts 25 and 26 instead of the grooves 25a and 26a.

The invention provides distinct advantages in that while a prior art attachment member does not have any flexibility, and multiple versions of such attachment member must be manufactured in practice, these drawbacks are not present in the invention. Furthermore, prior art attachment members are unsuitable for purposes such as wrapping whereas attachment members in accordance with the invention are suitable for wrapping. Finally, when a rubber material is used as the fiber material of prior art attachment members, the attachment member cannot be rigidly coupled with fixing members produced from polypropylene, and the attachment member becomes very much vulnerable to deterioration. This problem does not arise in attachment members in accordance with the invention.

With an attachment member according to the invention as described above, since an elastomer is used as the elongate member, the attachment member in its entirety or as a whole has expandability. Therefore, there is no need to manufacture multiple versions of attachment members having different lengths, i.e., only a single length attachment member is needed and the attachment member can be used for binding or wrapping something by expanding the elongate member. When the attachment member is used for suspending an item to be displayed, since the loop formed by the elongate member expands, various arrangements may be made in displaying the item. The attachment member can also be used to combine a plurality of items by taking advantage of the expandability of the elastomer. In addition, the hardness of the elastomer can be freely set depending on the use of the attachment member, and the elastomer may be colored and/or may be mixed with a metal. Thus, the attachment member can be provided as a product having elegant taste.

The invention provides two types of methods of manufacturing an attachment member as described above. It is difficult to bond a rubber material and polypropylene according to the related art because of the nature of those materials. According to methods disclosed above however, an elongate member constituted by an elastomer is inserted in a fixing element when the member is extrusion-molded. When double molding is employed, fixing elements at ends of an elastomer are fused and integrated with each other.

The methods of manufacturing an attachment member according to the invention are carried out as described above. Thus, the elongate member has advantages resulting from the use of an elastomer, e.g., expandability of the elongate member as a whole. As a result, there is no need for manufacturing multiple or plural variants of an attachment member having different lengths. An attachment member can be used for binding and wrapping purposes by expanding the elongate member thereof to tightly bind or wrap something. When the elongate member is used for suspending an item to be displayed, since the loop formed by the elongate member expands, various arrangements can be made in displaying the item. Further, the attachment member can be used to combine a plurality of items by taking advantage of the expandability thereof.

The hardness of the elastomer can be freely selected or adjusted in accordance with the purpose of use of the same. Further, the elastomer can be colored or mixed with metal powder or foil. Thus, the attachment member can be provided as a product having elegant taste, and the member can be also used as a decorative item.

According to one embodiment of a manufacturing method described above, a hard or rigid fixing element is first molded and is thereafter firmly coupled with an elastomer having an appropriate or desired length to serve as the elongate member. No additional requirements are placed on these manufacturing steps, and relevant operations can therefore be easily carried out. Thus, an attachment member can be provided at a low cost and can be finished with improved precision.

While particular embodiments of the invention have been shown and described, it will be obvious to those skilled in the art that changes and modifications may be made without departing from the invention in its broader aspects, and, therefore, the aim in the appended claims is to cover all such changes and modifications as fall within the true spirit and scope of the invention.

We claim:

1. An attachment member, comprising:
an elongate member made of elastomeric material; and
a rigid fixing element arranged in connection with at least one end of said elongate member.

2. The attachment member according to claim 1, wherein said elongate member is made entirely of elastomeric material.

3. The attachment member according to claim 1, wherein said elongate member consists of an elastomer.

4. The attachment member according to claim 1, wherein said elongate member is molded from an elastomer.

5. The attachment member according to claim 1, wherein said elongate member is a linear member having a substantially circular cross-sectional shape.

6. The attachment member according to claim 5, wherein said fixing element includes a receiving section arranged at a first end of said elongate member and having an engaging portion and an insertion section arranged at a second end of said elongate member and having an engagement portion configured to fit at least partially into or through said receiving section and engage with said engaging portion of said receiving section.

7. An attachment member assembly, comprising:
a plurality of attachment members according to claim 6;
a first runner member connected to said receiving sections of said attachment members; and
a second runner member connected to said insertion sections of said attachment members.

8. The attachment member according to claim 6, wherein said receiving section comprises an integral hook portion.

9. The attachment member according to claim 1, wherein said elongate member is in the form of a strip and said fixing element comprises a pair of clips each arranged at a respective end of said strip.

10. The attachment member according to claim 1, wherein said elongate member is in the form of a strip and said fixing element comprises a receiving section arranged at one end of said strip and having an engaging portion, and engagement portions arranged on one surface of said strip at and proximate another end thereof, said engagement portions being formed at substantially constant intervals and configured to engage with the engaging portion of said receiving section.

11. A method for manufacturing an attachment member, comprising:
extrusion-molding an elongate member from at least one elastomer, and
inserting the elongate member into a rigid fixing element.

12. A method for manufacturing an attachment member comprising:
injection-molding an elongate member from at least one elastomer;
cutting the elongate member into a desired length; and
attaching a hard fixing element to at least one end of the elongate member.

13. A method for manufacturing an attachment member including an elongate member molded from elastomeric material and a rigid fixing element arranged in connection with at least one end of the elongate member, the method comprising:
molding the fixing element; and then
firmly coupling the elastomeric elongate member with the fixing element.

14. The method for manufacturing an attachment member according to claim 13, wherein the fixing element is molded in two parts, a receiving section having an engaging portion and an insertion section having an engagement portion configured to fit at least partially into or through the receiving section and engage with the engaging portion of the receiving section, further comprising:
coupling the receiving section to one end of the elongate member;
coupling the insertion section to the other end of the elongate member.

15. The method for manufacturing an attachment member according to claim 13, further comprising providing the fixing element with a coupling shaft configured to be accommodated in an end portion of the elongate member.

16. The method for manufacturing an attachment member according to claim 15, further comprising forming the coupling shaft with a groove into which the elastomer enters to achieve rigid integration between the fixing element and the elongate member.

17. The method for manufacturing an attachment member according to claim 13, wherein the attachment is used as a rubber band for hair.
